(19) United States
(12) Patent Application Publication
(10) Pub. No.: US 2020/0352375 A1
(43) Pub. Date: Nov. 12, 2020

(54) SHOE TIE ASSISTING DEVICE

(71) Applicant: Lace Up Enterprises LLC, Euclid, OH (US)

(72) Inventor: Luis R. Vizcarrondo, Euclid, OH (US)

(21) Appl. No.: 16/408,034

(22) Filed: May 9, 2019

(51) Int. Cl. A47G 25/90; E06C 1/39

(52) U.S. Cl. CPC A47G 25/90; E06C 1/39

(57) ABSTRACT

There is provided a shoe tie-assisting device that allows a user to position themselves such that they can tie their own shoes. The shoe tie assisting device includes a frame assembly that includes support columns spaced to create a geometric space between them. The support columns are connected with support bars. The shoe tie-assisting device further includes a platform assembly positioned in the geometric space between the support columns. The platform assembly allows a user to place one of their feet thereon. The shoe tie-assisting device further includes a handle assembly having one or more components that the user can grasp. This component(s) are positioned at height that a user can grasp them from an upright position without having to bend over. Using the platform assembly and handle assembly, a user can position their body such that they can tie their own shoes.

### BACKGROUND

For people having certain health issues, some common, everyday tasks such as putting on and tying one's own shoes, is difficult to achieve. Putting on and tying shoes is particularly difficult for people with difficulty bending over or difficult bending over while maintaining their balance. Thus, such a person typically requires assistance from another person to complete such tasks. However, some people do not like to be dependent on others for what is for most people a simple task. Thus, there is a need for a device that allows a person with difficulty reaching their own feet to put on their own shoes to put on and tie their shoes without requiring assistance from another person.

U.S. Pat. No. 6,571,915 discloses a ladder for people with limited mobility. Example uses of the ladder include a person maneuvering between a wheelchair and a surface as shown in FIGS. 5-10 and a person moving from a surface to a standing position as shown in FIGS. 18-27. However, as shown in FIGS. 25-27, a person is required to bend over in order to reach the ladder, which is difficult to do for people with certain health issues.

### SUMMARY

There is provided a shoe tie-assisting device that allows a user to position themselves such that they can tie their own shoes. The shoe tie assisting device includes a frame assembly that includes support columns spaced to create a geometric space between them. The support columns are connected with support bars. The shoe tie-assisting device further includes a platform assembly positioned in the geometric space between the support columns. The platform assembly allows a user to place one of their feet thereon. The shoe tie-assisting device further includes a handle assembly having one or more components that the user can grasp. This component(s) are positioned at height that a user can grasp them from an upright position without having to bend over. Using the platform assembly and handle assembly, a user can position their body such that they can tie their own shoes.

### BRIEF DESCRIPTION OF THE FIGURES

FIG. 1A depicts an isometric view of a shoe tie-assisting device according to a first embodiment.

FIG. 1B depicts a front perspective view of the shoe tie-assisting device according to FIG. 1A.

FIG. 1C depicts a side perspective view of the shoe tie-assisting device according to FIG. 1A.

FIG. 2A depicts an isometric view of a shoe tie-assisting device according to a second embodiment.

FIG. 2B depicts a front perspective view of the shoe tie-assisting device according to FIG. 2A.

FIG. 2C depicts a side perspective view of the shoe tie-assisting device according to FIG. 2A.

FIG. 2D depicts a side perspective view of the shoe tie-assisting device according to FIG. 2A next to a person and a prior art device for height comparison.

FIG. 2E depicts a side perspective view of the shoe tie-assisting device according to FIG. 2A being used by a person.

FIG. 3A depicts an isometric view of a shoe tie-assisting device according to a third embodiment.

FIG. 3B depicts a front perspective view of the shoe tie-assisting device according to FIG. 3A.

FIG. 3C depicts a side perspective view of the shoe tie-assisting device according to FIG. 3A.

FIG. 4 depicts an isometric view of a shoe tie-assisting device according to a fourth embodiment.

FIG. 5 depicts an isometric view of a shoe tie-assisting device according to a fifth embodiment.

FIG. 6 depicts an isometric view of a shoe tie-assisting device according to a sixth embodiment.

FIG. 7 depicts an isometric view of a shoe tie-assisting device according to a seventh embodiment.

FIG. 8 depicts an isometric view of a shoe tie-assisting device according to an eighth embodiment.

FIG. 9 depicts an isometric view of a shoe tie-assisting device according to a ninth embodiment.

### DETAILED DESCRIPTION OF PREFERRED EMBODIMENTS

### First Embodiment

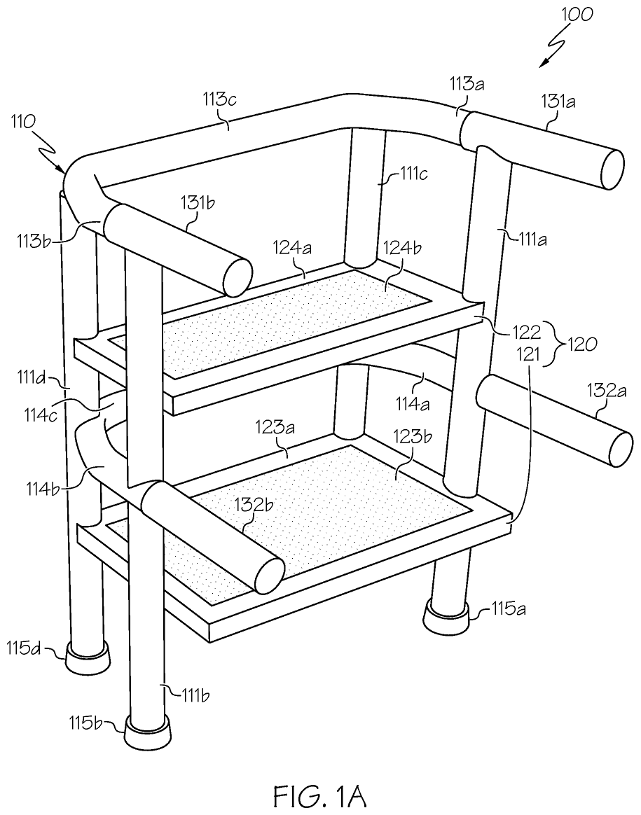

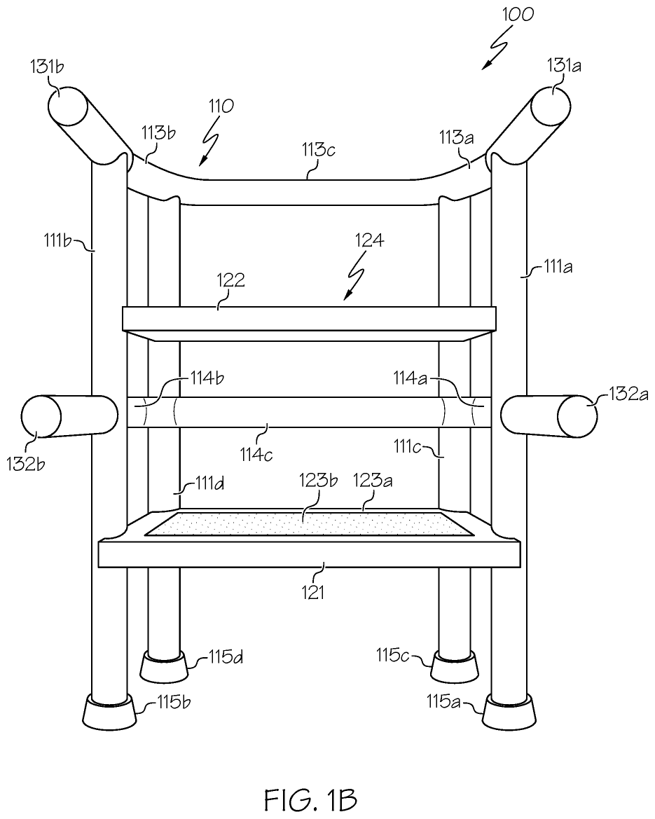

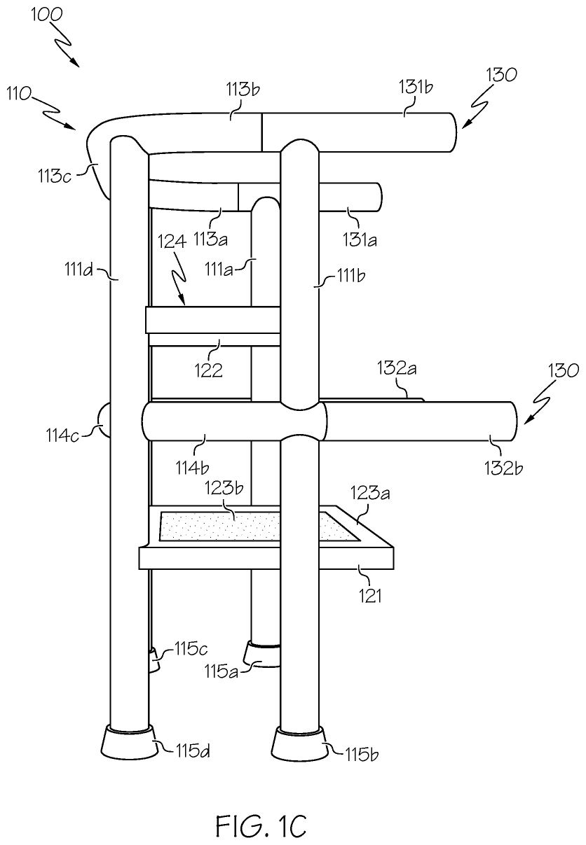

Referring to FIGS. 1A-1C, a shoe tie-assisting device 100 according to a first embodiment has a frame assembly 110 that includes four vertically-extending support columns 111 spaced to create a quadrilateral-shaped area therebetween.

A foot-resting platform assembly 120 is positioned between the support columns 111 and includes a first platform base 121 and a second platform base 122. The first platform base 121 has a generally rectangular shape that is connected to all four support columns 111, extending in a generally horizontal direction. The front of the first platform base 121 extends past the front support columns 111a, 111b. In alternative embodiments, the first platform base 121 can connect to fewer than all of the support columns 111, such as only the back support columns 111c, 111d. The first platform base 121 includes a first platform surface 123a, which is partially covered in an anti-slip material 123b. Similarly, the second platform base 122 has a rectangular shape that is connected to all four support columns 111, extending in a generally horizontal direction. The front of the second platform base does not extend as far horizontally as the first platform base 121 (see FIG. 1C). The second platform base 122 includes a second platform surface 124a also partially covered in an anti-slip material 124b. The second platform surface 124a is configured in a stepped relationship with the first platform surface 123.

As depicted, the platform bases 121, 122 are fixed to the support columns 111. However, in alternative embodiments, the platform bases 121, 122 can be configured to height adjustable. For example, the platform bases 121, 122 may be attached to the support columns 111 via adjustable securing means. The platform bases 121, 122 can be configured to be manually adjusted. Alternatively, the shoe tie-assisting device 100 can include electronic components that allow the platform bases 121, 122 to be adjusted.

The frame assembly 110 also includes horizontally-extending upper support bars 113, which serve to connect the upper ends of the support frames 111. Specifically, the front right support column 111a is connected to the back right support column 111c with right upper support bar 113a; the front left support column 111b is connected to the back left support column 111d with left upper support bar 113b; and the back right support column 111c is connected to the back left support column 111d with back upper support bar 113c. The front right support column 111a is not directly connected to the front left support column 111b with an upper support bar 113 such that the area between the support columns 111 is open from the front direction. As depicted, the upper support bars 113 are all segments of a single piece bent to form the respective support bars 113a, 113b, 113c. Thus, the transitions between the right upper support bar 113a and the back upper support bar 113c as well as the left upper support bar 113b and the back upper support bar 113c are curved. In alternative embodiments, each support bar 113a, 113b, 113c can be a separate piece, all optionally directly secured to one another.

Extending at an angle from the upper ends the front support columns 111a, 111b are a first pair of handles 131a, 131b. The handles 131a, 131b can be extended sections of the upper support bars 113a, 113b (as depicted), or the handles 131a, 131b can be separate pieces. If the handles 131a, 131b are separate pieces from the upper support bars 113a, 113b, they can positioned at the same or a different height along the front support columns 111a, 111b. The handles 131a, 131b can be covered with a gripping material, e.g. a rubber or foam, which allows a user to grip the handles without the risk that their hands will slip off of the handles.

The frame assembly 110 also includes horizontally-extending intermediate support bars 114, which serve to connect the support frames 111 at an intermediate height between their upper ends and lower ends. Specifically, the front right support column 111a is connected to the back right support column 111c with right intermediate support bar 114a; the front left support column 111b is connected to the back left support column 111d with left intermediate support bar 114b; and the back right support column 111c is connected to the back left support column 111d with back intermediate support bar 114c. Again, the front right support column 111a is not directly connected to the front left support column 111b with an intermediate support bar 114 such that the area between the support columns 111 is open from the front direction. As depicted, the intermediate support bars 114 are all segments of a single piece bent to form the respective support bars 114a, 114b, 114c. Thus, the transitions between the right intermediate support bar 114a and the back intermediate support bar 114c as well as the left intermediate support bar 114b and the back intermediate support bar 114c are curved. In alternative embodiments, each support bar 114a, 114b, 114c can be a separate piece, all optionally directly secured to one another.

Extending at an angle from the intermediate height of the front support columns 111a, 111b are a second pair of handles 132a, 132b. The handles 132a, 132b can be extended sections of the intermediate support bars 114a, 114b, or the handles 132a, 132b can be separate pieces. The handles 132a, 132b can be covered with a gripping material, e.g. a rubber or foam, which allows a user to grip the handles without the risk that their hands will slip off of the handles. Together the first pair of handles 131 and second pair of handles 132 constitute a handle assembly 130. The highest vertical handle(s) of the handle assembly 130, the first pair of handles 131 as depicted, are preferably at a height that can be reached by persons within a typical height range (e.g. 4′6″ to 6′6″) without requiring them to bend over. For example, the first pair of handles 131 are preferably at height of at least 24 inches, more preferably at least 30 inches, and most preferably at least 36 inches. In this regard, as described in more detail below, the person can grasp a portion of the device without bending over.

As depicted, the handles 131, 132 are fixed in their locations. However, in alternative embodiments, either or both pairs of handles 131, 132 could be height adjustable such that a user could customize their location. For example, the handles 131, 132 may be attached to the support columns 111 via adjustable securing means. Alternatively, the support columns 111 themselves may be height adjustable. For example, each support column 111 may be configured as a pair of telescoping columns such that the upper portion of the column connected to the handles 131, 132 may be raised or lowered to a desired height. The height of the handles 131, 132 can be configured to be manually adjusted. Alternatively, the shoe tie-assisting device 100 can include electronic components that allow the handles 131, 132 to be adjusted.

At the base of the bottom ends of the support columns 111 are base portions 115. These base portions 115 are preferably made of a non-slip material, e.g. a rubber, which can engage several floor surface types with a high degree of friction such that the shoe tie-assisting device 100 does not slide along the floor during use. As depicted, the base portions 115a, 115b, 115c, 115d are end-caps covering the bottom ends of the support columns 111a, 111b, 111c, 111d. However, other types of base portions are contemplated.

In alternative embodiments, the frame 110 need not include all of the upper support bars 113 and the intermediate support bars 114. Specifically, it is preferred that the front right support column 111a is connected with the back right support column 111c at at least two different heights, the back right support column 111c is connected with the back left support column 111d at at least two different heights, and the front left support column 111b is connected with the back left support column 111d at at least two different heights. This can be achieved with a variety of combinations of the upper support bars 113 and the intermediate support bars 114. Additionally, the platform bases 121, 122 can constitute a connection between adjacent support columns 111.

The components of the first shoe tie-assisting device 100 can be made from various materials provided they provide adequate structural support for supporting the body weight of a user without the device 100 tipping. In one example, the support columns 111, the upper support bars 113, the intermediate support bars 114, platform bases 121, 122, and handles 131, 132 can be made of a metal material such as stainless steel. These components can be made via various processes, i.e. die-casting. These components can be connected together in various ways, such as by welding or via fasteners, such as screws, bolts, etc. In alternative embodiments, the platform bases 121, 122 can be made of a plastic material.

In one example method of utilizing the shoe tie-assisting device 100, from a standing position without bending over, a user first grips the first pair of handles 131a, 131b with each of their hands, respectively. The user then lifts the foot having the shoe to be tied/untied onto the platform assembly 120. The user can lift the foot to the first platform surface 124 and thereafter the second platform surface 125 if desired. The user then lowers their upper body toward the platform assembly 120, which can include moving a first of their hands from the one of the first pair of handles 131a, 131b to one of the second pair of handles 132a, 132b, and thereafter moves their second hand from the other handle 131a, 131b to the other handle 132a, 132b. From this position, the user can reach the shoe on the platform assembly 120 with his/her hands so that it can be tied/untied. Once the tying/untying is complete, the user can return to a fully upright position be reversing the order in which he lowered himself.

It is contemplated that the shoe tie-assisting device 100 can be about three feet wide, two feet deep, and four feet tall. However, other dimensions are also contemplated provided they allow a user to tie their own shoes.

In alternative embodiments, the shoe tie-assisting device 100 can be configured to be collapsible to reduce the space it occupies, for example during packaging or shipping. For example, the platform assembly 120 may be configured to rotate out of the quadrilateral-shaped area defined by the support columns 111. This can be achieved by the platform bases 121, 122 being rotatably secured to the rear support columns 111c, 111d. Further, the front support columns 111a, 111b may be configured to rotate to positions nearer the rear support columns 111c, 111d. For example, with platform assembly 120 rotated out of the way, the support bars 113a, 114a can be rotatable about their connection to the rear right support column 111c such that the front right support column 111a rotates to a position nearer to the rear left support column 111d. Similarly, the support bars 113b, 114b can be rotatable about their connection to the rear left support column 111dc such that the front left support column 111n rotates to a position nearer to the rear right support column 111c. The shoe tie-assisting device 100 can be manually collapsible. Alternatively, the shoe tie-assisting device 100 can include electronic components that cause its components to collapse.

### Second Embodiment

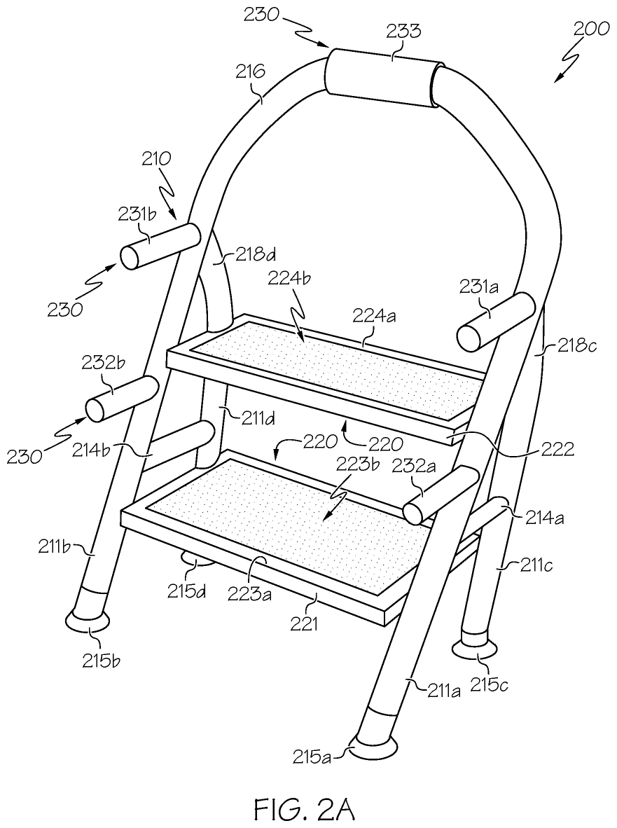

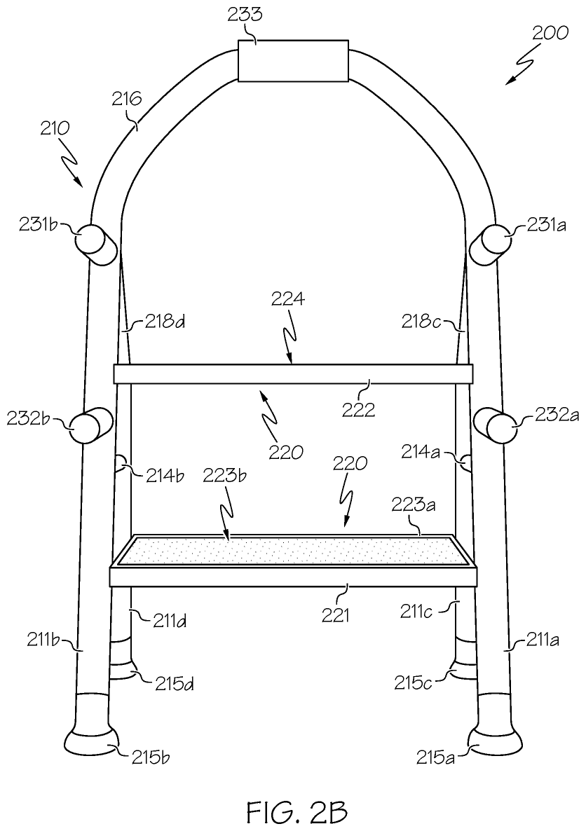

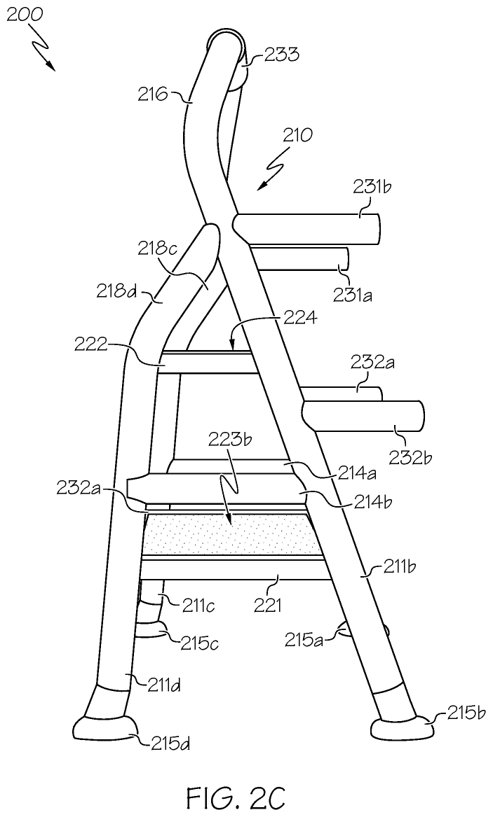

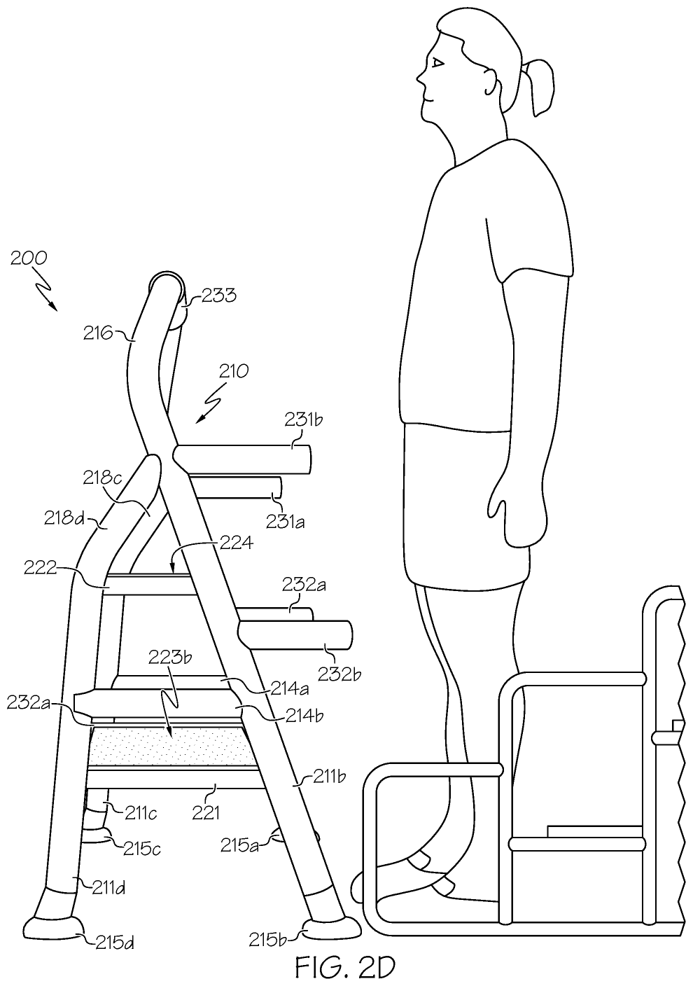

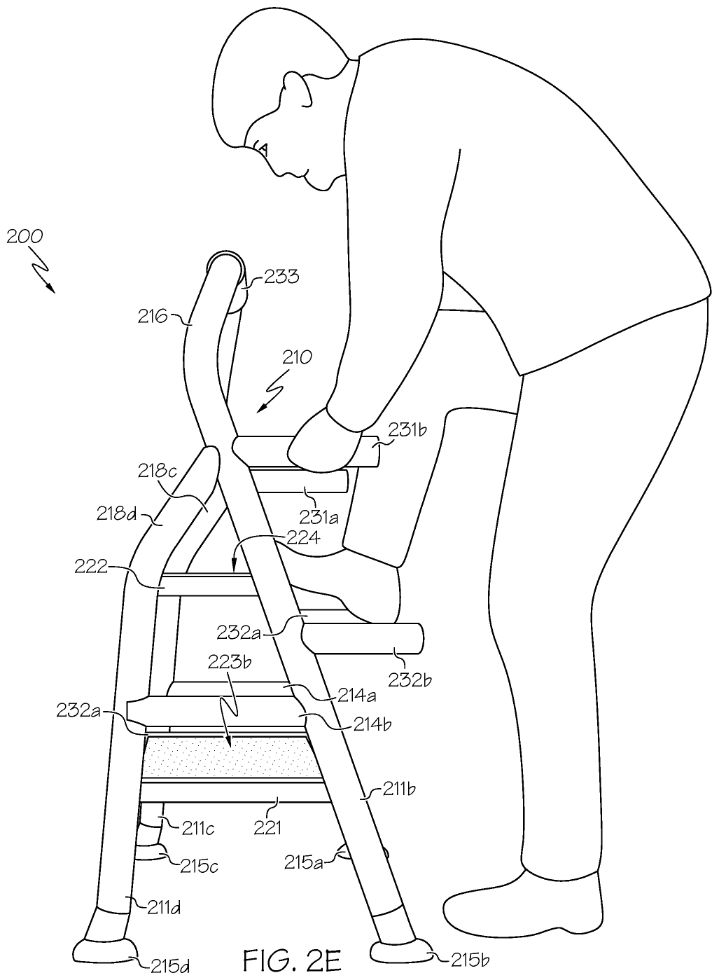

Referring to FIGS. 2A-2C, a shoe tie-assisting device 200 according to a second embodiment is similar has a frame assembly 210 that includes four support columns 211 that are spaced and their lower ends to create a rectangular space in a horizontal plane therebetween. The support front support columns 211a, 211b are angled with respect to the rear support columns 211c, 211d such that the distance between them gradually decreases in the upward direction (see FIG. 2C). The upper ends of the rear support columns 211c, 211d include bent sections 218c, 218d which are bent towards the front support columns 211a, 211b. The bent sections 218c, 218d are angled to hasten the gradual decrease in distance between as well as connect the rear support columns 211c, 211d and front support columns 211a, 211b.

A foot-resting platform assembly 220 is positioned between the support columns 211 and includes a first platform base 221 and a second platform base 222. The first platform base 221 has a generally rectangular shape that is connected at its corners to all four support columns 211, extending in a generally horizontal direction. In alternative embodiments, the first platform base 221 can extend outside of the area between the support columns 211, such as past the front support columns 211a, 211b. The first platform base 221 includes a first platform surface 223a partially covered in an anti-slip material 223b. Similarly, the second platform base 222 has a rectangular shape that is connected at its corners to all four support columns 211, extending in a generally horizontal direction. Because the distance between the front support columns 211a, 211b and rear support columns 211c, 211d decrease in the upwards direction, the front of the second platform base 222 does not extend as far horizontally as the first platform base 221 (see FIG. 2C). The second platform base 222 includes a second platform surface 224a also partially covered in an anti-slip material 224b. The second platform surface 224a is configured in a stepped relationship with the first platform surface 223a.

The frame assembly 210 also includes an upwardly-extending, curved upper support bar 216 extending from the upper ends of and connecting the front support frames 211a, 211b. The central portion of the upper support bar 216 is covered with a gripping material, e.g. a rubber or foam, to create a handle section 233. The gripping material allows a user to grip the handles without the risk that their hands will slip off of the handle section 233. In alternative embodiments, the upper support bar 216 can be formed of straight segments connected to one another to form a generally curved shape.

Extending at an angle from the upper ends the front support columns 211a, 211b are a first pair of handles 231a, 231b. As depicted, the handles 231a, 231b are covered with a gripping material, e.g. a rubber or foam, which allows a user to grip the handles without the risk that their hands will slip off of the handles 231.

The frame assembly 210 also includes horizontally-extending intermediate support bars 214 which connect the support columns 211 at an intermediate height between their upper ends and lower ends. A right intermediate support bar 214a extends from the front right support column 211a to the back right support column 211c, and a left intermediate support bar 214b extends from the front left support column 211c to the back left support column 211d. An intermediate support bar 214 does not extend between the front right support column 211a and the front left support column 211b such that the rectangular area between the support columns 211 is open from the front direction. Additionally, as depicted, an intermediate support bar 214 does not extend between the back right support column 211c and the back left support column 211d. However, in alternative embodiments, an intermediate support bar 214 can extend between these columns 211c, 211d for additional stability.

Extending at an angle from an intermediate height of the front support columns 211a, 211b are a second pair of handles 232a, 232b. As depicted, the handles 232a, 232b are covered with a gripping material, e.g. a rubber or foam, which allows a user to grip the handles without the risk that their hands will slip off of the handles 232. Also as depicted, the second pair of handles 232a, 232b are at the same height as the intermediate support bars 214. However, in alternative embodiments, the second pair of handles 232a, 232b can extend at a different height than the intermediate support bars 214. Together, the first pair of handles 231, second pair of handles 232, and handle section 233 of the upper support bar 216 constitute a handle assembly 230. The highest vertical handle(s) of the handle assembly 230, the handle section 233 as depicted, are preferably at a height that can be reached by persons within a typical height range (e.g. 4′6″ to 6′6″) without requiring them to bend over. For example, the handle section 233 is preferably at height of at least 24 inches, more preferably at least 30 inches, and most preferably at least 36 inches. In this regard, as described in more detail below, the person can grasp a portion of the device without bending over. FIG. 2D depicts an example of the height of the shoe-tie assisting device next to a person. It is clear that the person can reach at least the handle section 233 without bending over.

At the base of the bottom ends of the support columns 211 are base portions 215. These base portions 215 are preferably made of a material, e.g. a rubber, which can engage several floor surface types with a high degree of friction such that the shoe tie-assisting device 200 does not slide along the floor during use. As depicted, the base portions 215a, 215b, 215c, 215d are end-caps covering the bottom ends of the support columns 211a, 211b, 211c, 211d.

Like the first shoe tie-assisting device 100, the components of the second shoe tie-assisting device 200 can be made from various materials provided they provide adequate structural support for supporting the body weight of a user without the device 200 tipping. In one example, the support columns 211, the upper support bar 216, the intermediate support bar 214, platform bases 221, 222, and handles 231, 232 can be made of a metal material such as stainless steel. These components can be made via various processes, i.e. die-casting. These components can be connected together in various ways, such as by welding or via fasteners, such as screws, bolts, etc. Additionally, the platform bases 221, 222 can be made of a plastic material.

In one example method of utilizing the shoe tie-assisting device 200, from a standing position without bending over, a user first grips the handle section 233 of the upper support bar 216. The user can then lift the foot having the shoe to be tied/untied onto the platform assembly 220 and then move their hands to the first pair of handles 231a, 231b, or vice-versa (see FIG. 2E). When lifting the foot to the platform assembly 220, the user can lift the foot to the first platform surface 221 and thereafter the second platform surface 222 if desired (see FIG. 2E). The user then lowers their upper body toward the platform assembly 220, optionally by moving a first of their hands from the one of the first pair of handles 231a, 231b to one of the second pair of handles 232a, 232b, and thereafter moves their second hand from the other handle 231a, 231b to the other handle 232a, 232b. From this position, the user can reach the shoe on the platform assembly 220 with his/her hands so that it can be tied/untied. Once the tying/untying is complete, the user can return to a fully upright position be reversing the order in which he lowered himself.

Similar to the shoe tie-assisting device 100, the shoe tie-assisting device 200 can be designed to be collapsible to reduce the space it occupies. Additionally, the components of the platform assembly 220 and the handle assembly 230 can be made to be adjustable so that persons of different heights can be comfortably accommodated.

### Third Embodiment

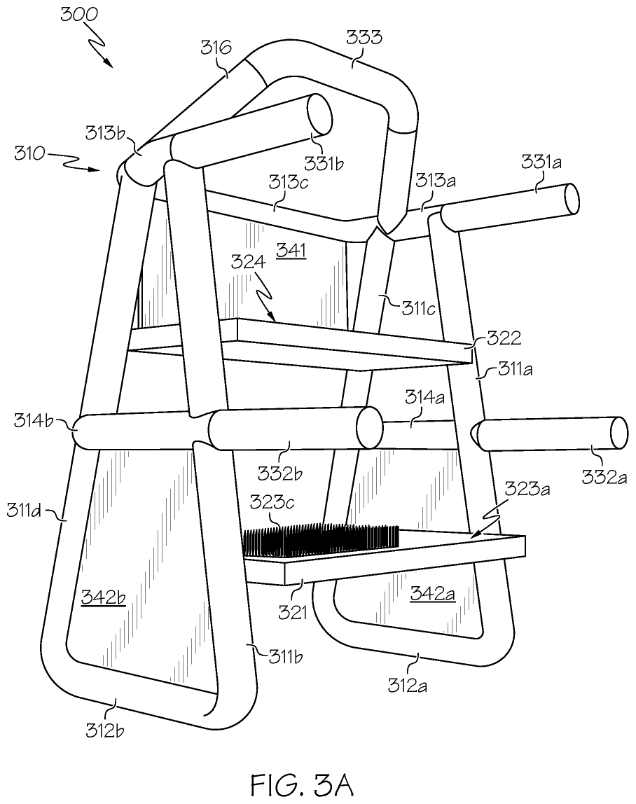

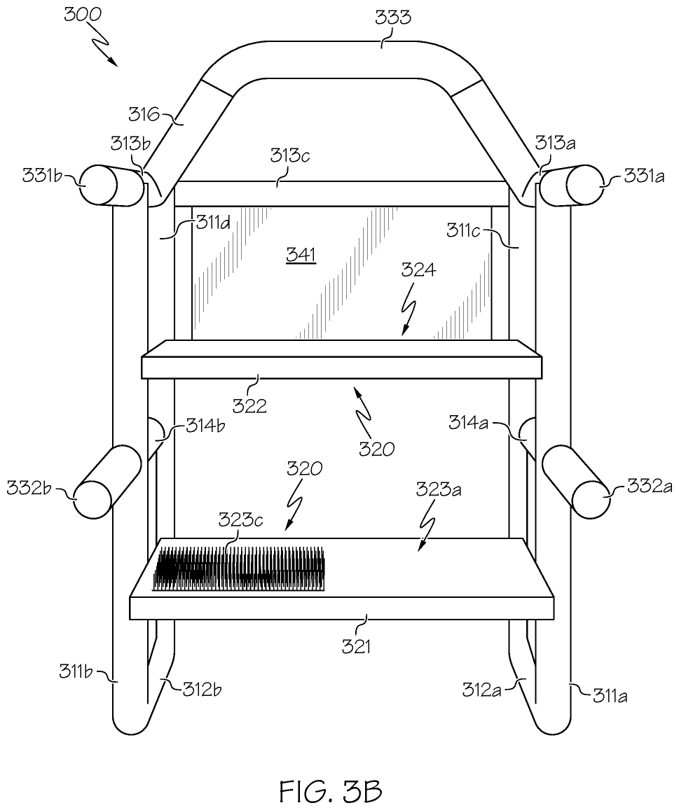

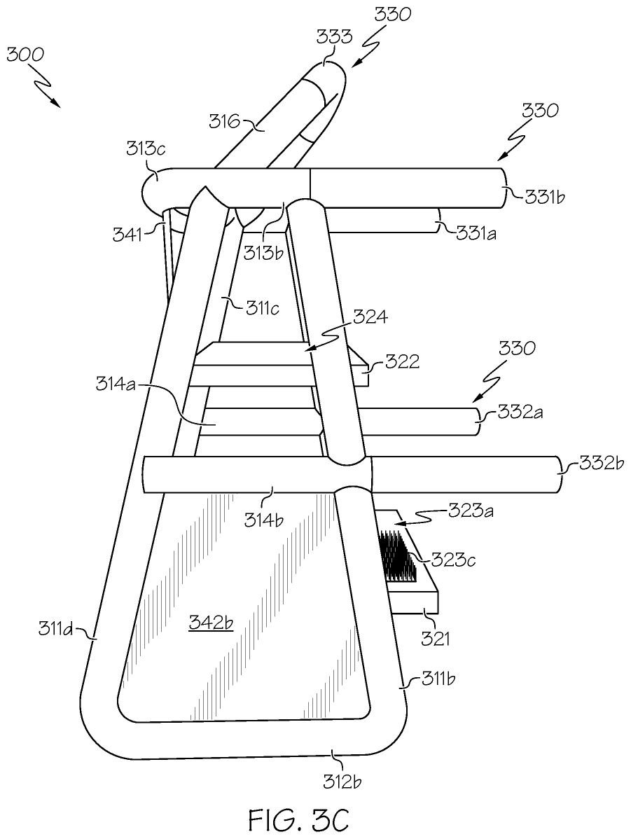

Referring to FIGS. 3A-3C, a shoe tie-assisting device 300 according to a third embodiment is similar to the second embodiment described above with some modified features. The shoe tie-assisting device 300 has a frame assembly 310 that includes four support columns 311 that are spaced and their lower ends to create a rectangular space in a horizontal plane therebetween. The support front support columns 311a, 311b are angled with respect to the rear support columns 311c, 311d such that the distance between them gradually decreases in the upward direction (see FIG. 3C).

A foot-resting platform assembly 320 is positioned between the support columns 311 and includes a first platform base 321 and a second platform base 322. The first platform base 321 has a generally rectangular shape that is connected to all four support columns 311, extending in a generally horizontal direction. The first platform base 321 includes a first platform surface 323a partially covered in an anti-slip material 323b and partially covered with bristles to clean bottom surface of shoes. Similarly, the second platform base 322 has a rectangular shape that is connected to all four support columns 311, extending in a generally horizontal direction. Both the first platform base 321 and second platform base 322 extend partially past the front support columns 311a, 311b (see FIG. 3C). The second platform base 322 includes a second platform surface 324a also partially covered in an anti-slip material 324b. The second platform surface 324a is configured in a stepped relationship with the first platform surface 323a.

The frame assembly 310 also includes horizontally-extending upper support bars 313, which serve to connect the upper ends of the support frames 311. Specifically, the front right support column 311a is connected to the back right support column 311c with right upper support bar 313a; the front left support column 311b is connected to the back left support column 311d with left upper support bar 313b; and the back right support column 311c is connected to the back left support column 311d with back upper support bar 313c. The front right support column 311a is not directly connected to the front left support column 311b with an upper support bar 313 such that the area between the support columns 311 is open from the front direction. As depicted, the upper support bars 313 are all segments of a single piece bent to form the respective support bars 313a, 313b, 313c. Thus, the transitions between the right upper support bar 313a and the back upper support bar 313c as well as the left upper support bar 313b and the back upper support bar 313c are curved. In alternative embodiments, each support bar 313a, 313b, 313c can be a separate piece secured to one another.

Extending at an angle from the upper ends the front support columns 311a, 311b are a first pair of handles 331a, 331b. The handles 331a, 331b can be extended sections of the upper support bars 313a, 313b (as depicted), or the handles 331a, 331b can be separate pieces. As depicted, the handles 331a, 331b are covered with a gripping material, e.g. a rubber or foam, which allows a user to grip the handles without the risk that their hands will slip off of the handles.

The frame assembly 310 also includes horizontally-extending intermediate support bars 314, which serve to connect the support frames 311 at an intermediate height between their upper ends and lower ends. Specifically, the front right support column 311a is connected to the back right support column 311c with intermediate support bar 314a; the front left support column 311b is connected to the back left support column 311d with intermediate support bar 314b; and the back right support column 311c is connected to the back left support column 311d with back intermediate support bar 314c. The front right support column 311a is not directly connected to the front left support column 311b with an intermediate support bar 314 such that the area between the support columns 311 is open from the front direction. As depicted, the intermediate support bars 314 are all segments of a single piece bent to form the respective support bars 314a, 314b, 314c. Thus, the transitions between the right intermediate support bar 314a and the back intermediate support bar 314c as well as the left intermediate support bar 314b and the back intermediate support bar 314c are curved. In alternative embodiments, each support bar 314a, 314b, 314c can be a separate piece secured to one another.

Extending at an angle from an intermediate height of the front support columns 311a, 311b are a second pair of handles 332a, 332b. The handles 332a, 332b can be extended sections of the intermediate support bars 314a, 314b (as depicted), or the handles 332a, 332b can be separate pieces. As depicted, the handles 332a, 332b are covered with a gripping material, e.g. a rubber or foam, which allows a user to grip the handles without the risk that their hands will slip off of the handles.

The frame assembly 310 also includes an upwardly-extending, curved upper support bar 316 extending from the upper support bars 313a, 313b. The central portion of the upper support bar 316 is covered with a gripping material, e.g. a rubber or foam, to create a handle section 333. The gripping material allows a user to grip the handles without the risk that their hands will slip off of the handle section 333. Together, the first pair of handles 231, second pair of handles 232, and handle section 233 of the upper support bar 216 constitute a handle assembly 230.

The frame assembly 310 also includes lower support bars 312 connecting the lower ends of the front support columns 311a, 311b to the lower ends of the rear support columns 311c, 311d. Specifically, A right lower support bar 312a extends from the lower end of the front right support column 311a to the lower end of the back right support column 311c, and a left lower support bar 312b extends from the lower end of the front left support column 311c to the lower end of the back left support column 311d. As depicted, the front right support column 311a, right lower support bar 312a, and rear right support column 311c, as well as the front left support column 311b, left lower support bar 312b, and rear left support column 311d are segments of a single bent piece to form the respective support columns 311 and support bars 312. Thus, the transitions between these support columns and support bars 312 are curved. In alternative embodiments, each support column 311 and lower support bar 312 can be a separate piece secured to one another.

Below the lower support bars 312 can be base portions (not shown). The base portions are preferably made of a material, e.g. a rubber, which can engage several floor surface types with a high degree of friction such that the shoe tie-assisting device 300 does not slide along the floor during use.

Like the first and second shoe tie-assisting devices 100, 200, the components of the third shoe tie-assisting device 300 can be made from various materials provided they provide adequate structural support for supporting the body weight of a user without the device 300 tipping. In one example, the support columns 311, the lower support bars 312, the upper support bars 313, the intermediate support bars 314, the platform bases 321, 322, and the handles 331, 332 can be made of a metal material such as stainless steel. These components can be made via various processes, i.e. die-casting. These components can be connected together in various ways, such as by welding or via fasteners, such as screws, bolts, etc. Additionally, the platform bases 323, 324 can be made of a plastic material.

In one example method of utilizing the shoe tie-assisting device 300, from a standing position without bending over, a user first grips the handle section 333 of the upper support bar 316. The user can then lift the foot having the shoe to be tied/untied onto the platform assembly 320 and then move their hands to the first pair of handles 331a, 331b, or vice-versa. When lifting the foot to the platform assembly 320, the user can lift the foot to the first platform surface 321 and thereafter the second platform surface 322 if desired. The user then lowers their upper body toward the platform assembly 320, optionally by moving a first of their hands from the one of the first pair of handles 331a, 331b to one of the second pair of handles 332a, 332b, and thereafter moves their second hand from the other handle 331a, 331b to the other handle 332a, 332b. From this position, the user can reach the shoe on the platform assembly 320 with his/her hands so that it can be tied/untied. Once the tying/untying is complete, the user can return to a fully upright position be reversing the order in which he lowered himself.

Similar to the shoe tie-assisting devices discussed above, the shoe tie-assisting device 300 can be designed to be collapsible to reduce the space it occupies. Additionally, the components of the platform assembly 320 and the handle assembly 330 can be made to be adjustable so that persons of different heights can be comfortably accommodated.

### Fourth Embodiment

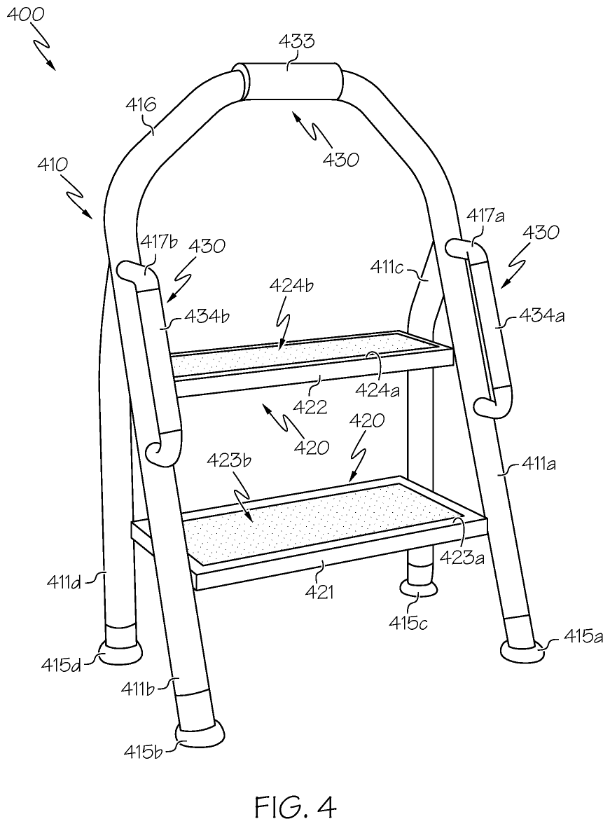

Referring to FIG. 4, a shoe tie-assisting device 400 according to a fourth embodiment is similar to the second embodiment described above with some modified features. Like the second embodiment, the shoe tie-assisting device 400 according to the fourth embodiment includes a frame assembly 410 that includes support columns 411 and an upper support bar 416; a platform assembly 420 that includes platform bases 421, 422 having platform surfaces 423a, 424a both partially covered with an anti-slip material 423b, 424b; and a handle assembly 430 including a handle section 433 of the upper support bar 416. However, the shoe tie-assisting device 400 does not have handles similar to the first and second pair of handles 231, 232. Instead, the frame assembly 410 includes handle supports 417a, 417b extending from the front support columns 411a, 411b. The handle supports 417a, 417b are U-shaped with their ends connected and their middle portions generally parallel to the front support columns 411a, 411b. The middle portions of the handle supports 417a, 417b are covered with a gripping material, e.g. a rubber or foam, to form handle sections 434a, 434b.

Similar to the shoe tie-assisting devices discussed above, the shoe tie-assisting device 400 can be designed to be collapsible to reduce the space it occupies. Additionally, the components of the platform assembly 420 and the handle assembly 430 can be made to be adjustable so that persons of different heights can be comfortably accommodated.

### Fifth Embodiment

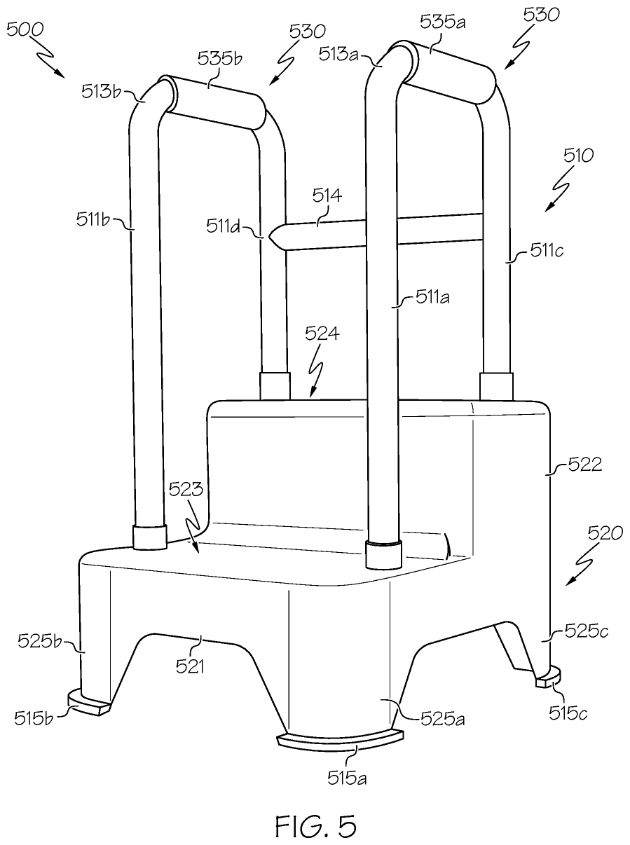

Referring to FIG. 5, a shoe tie-assisting device 500 according to a fifth embodiment has a frame assembly that includes four vertically-extending support columns 511 to create a quadrilateral-shaped space therebetween.

The support columns 511 extend vertically upwards from a foot-resting platform assembly 520 in the form of a platform base that includes a first, lower base section 521 and a second, upper base section 522. The front support columns 511a, 511b extend from first base section 521 and the rear support columns 511c, 511d extend from the second base section 522. The platform base 521, 522 can be made of a plastic material and resembles a set of stairs and the first base section 521 includes a first platform surface 523. The second base section 522 is disposed above the rear portion of the first base section 521 behind the first platform surface 524, and includes a second platform surface 524. The platform surface 523, 524 can optionally be partially covered in an anti-slip material. The platform assembly 520 includes four downwardly-extending legs 525, which extend from the lower side of the first base section 521. The legs 525 each include a base portion 515 which engage a floor surface. The base portions 515 can be made of or include a material, e.g. a rubber, which can engage several floor surface types with a high degree of friction such that the shoe tie-assisting device 500 does not slide along the floor during use.

The frame assembly 510 also includes horizontally-extending upper support bars 113, which serve to connect the upper ends of the support frames 111. Specifically, the front right support column 511a is connected to the back right support column 511c with right upper support bar 513a and the front left support column 511b is connected to the back left support column 511d with left upper support bar 513b. The upper support bars 513a, 513b are each respectively covered with a gripping material, e.g. a rubber or foam, to create handle sections 535a, 535b. The gripping material allows a user to grip the handles without the risk that their hands will slip off of the handle sections 535a, 535b. The handle sections 535a, 535b together constitute a handle assembly 530.

The frame assembly 510 also includes an intermediate support bar 514 extending between the rear support columns 511c, 511d at an intermediate height thereof. The components of the frame assembly 510 can be made of a metal material such as stainless steel. These components can be made via various processes, i.e. die-casting. These components can be connected together in various ways, such as by welding or via fasteners, such as screws, bolts, etc.

Similar to the shoe tie-assisting devices discussed above, the shoe tie-assisting device 500 can be designed to be collapsible to reduce the space it occupies. Additionally, the components of the platform assembly 520 and the handle assembly 530 can be made to be adjustable so that persons of different heights can be comfortably accommodated.

### Sixth Embodiment

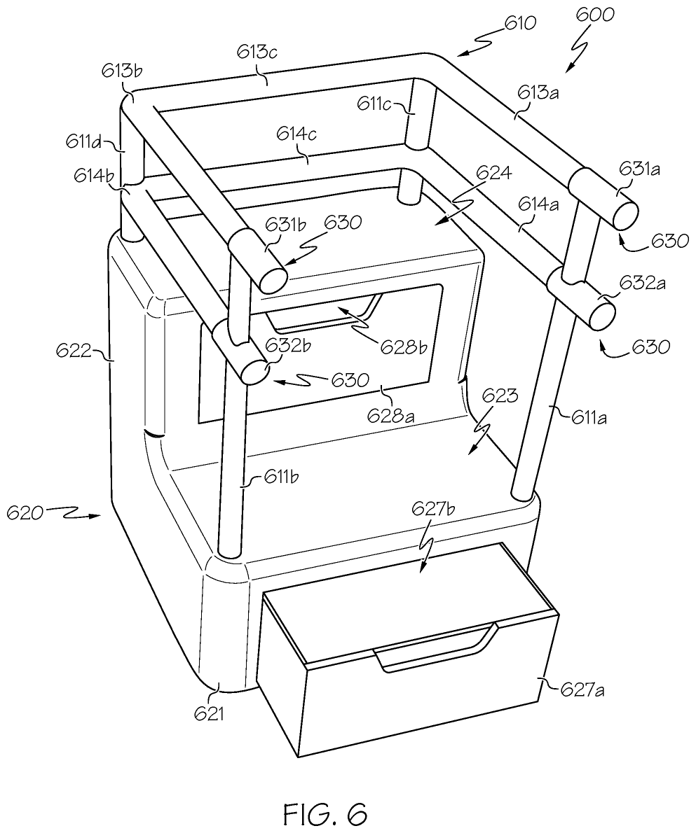

Referring to FIG. 6, a shoe tie-assisting device 600 according to a sixth embodiment has a frame assembly that includes four vertically-extending support columns 611 to create a quadrilateral-shaped space therebetween.

The support columns 611 extend vertically upwards from a foot-resting platform assembly 620 in the form of a platform base that includes a first, lower base section 621 and a second, upper base section 622. The front support columns 611a, 611b extend from first base section 621 and the rear support columns 611c, 611d extend from the second base section 622. The platform base 621, 622 can be made of a plastic material and resembles a set of stairs and the first base section 621 includes a first platform surface 623. The second base section 622 is disposed above the rear portion of the first base section 621 behind the first platform surface 624, and includes a second platform surface 624. The platform surface 623, 624 are partially covered in an anti-slip material. The lower base section 621 includes a slidable storage drawer 627a defining a storage space 627b for storing items, such as shoes. Similarly, the upper base section 622 includes a slidable storage drawer 628a defining a storage space 628b for storing items, such as shoes. The platform base 621, 622 is designed to sit on a floor surface, and can optionally include base portions, such as strips (not shown) made of a material, e.g. a rubber, which can engage several floor surface types with a high degree of friction such that the shoe tie-assisting device 600 does not slide along the floor during use.

The frame assembly 610 also includes horizontally-extending upper support bars 613, which serve to connect the upper ends of the support frames 611. Specifically, the front right support column 611a is connected to the back right support column 611c with right upper support bar 613a; the front left support column 611b is connected to the back left support column 611d with left upper support bar 613b; and the back right support column 611c is connected to the back left support column 611d with back upper support bar 613c. The front right support column 611a is not directly connected to the front left support column 611b with an upper support bar 613 such that the area between the support columns 611 is open from the front direction.

Extending at an angle from the upper ends the front support columns 611a, 611b are a first pair of handles 631a, 631b. The handles 631a, 631b can be extended sections of the upper support bars 613a, 613b (as depicted), or the handles 631a, 631b can be separate pieces. As depicted, the handles 631a, 631b are covered with a gripping material, e.g. a rubber or foam, which allows a user to grip the handles without the risk that their hands will slip off of the handles.

The frame assembly 610 also includes horizontally-extending intermediate support bars 614, which serve to connect the support frames 611 at an intermediate height between their upper ends and lower ends. Specifically, the front right support column 611a is connected to the back right support column 611c with right intermediate support bar 614a; the front left support column 611b is connected to the back left support column 611d with left intermediate support bar 614b; and the back right support column 611c is connected to the back left support column 611d with back intermediate support bar 614c. Again, the front right support column 611a is not directly connected to the front left support column 611b with an intermediate support bar 614 such that the area between the support columns 611 is open from the front direction.

Extending at an angle from the intermediate height of the front support columns 611a, 611b are a second pair of handles 632a, 632b. The handles 632a, 632b can be extended sections of the intermediate support bars 614a, 614b, or the handles 632a, 632b can be separate pieces. The handles 632a, 132b can be covered with a gripping material, e.g. a rubber or foam, which allows a user to grip the handles without the risk that their hands will slip off of the handles. Together the first pair of handles 631 and second pair of handles 632 constitute a handle assembly 630.

Similar to the shoe tie-assisting devices discussed above, the shoe tie-assisting device 600 can be designed to be collapsible to reduce the space it occupies. Additionally, the components of the platform assembly 620 and the handle assembly 630 can be made to be adjustable so that persons of different heights can be comfortably accommodated.

### Seventh Embodiment

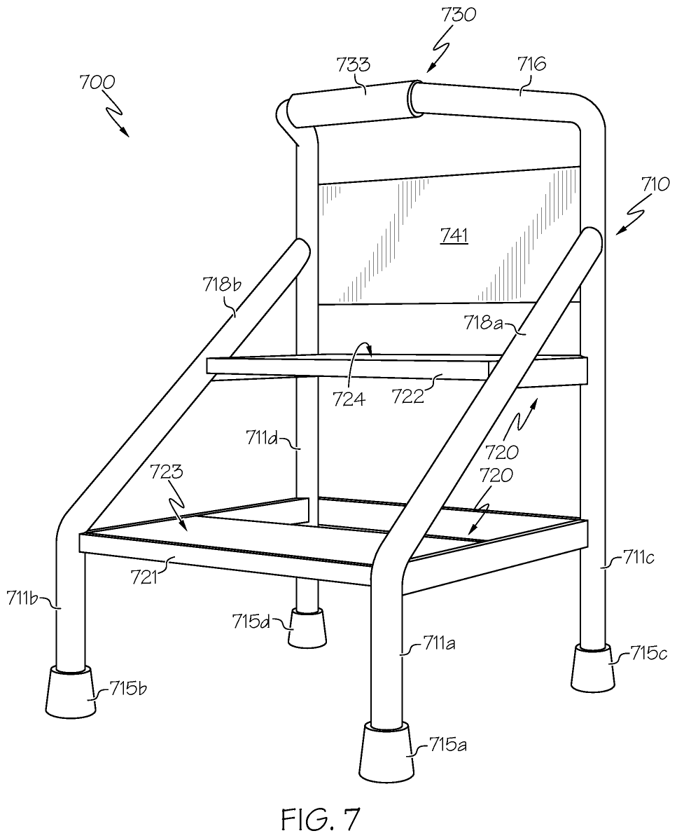

Referring to FIG. 7, a shoe tie-assisting device 700 according to a sixth embodiment has a frame assembly that includes four support columns 711 to create a quadrilateral-shaped space therebetween. The rear support columns 711c, 711d are vertically-extending throughout their length, whereas the lower sections of the front support columns 711a, 711b are vertically-extending but their upper sections 718a, 718b are bent to be angled towards and connect with the rear support columns 711c, 711d.

A foot-resting platform assembly 720 is positioned between the support columns 111 and includes a first platform base 721 and a second platform base 722. The first platform base 721 has a generally rectangular shape that is connected to all four support columns 711, extending in a generally horizontal direction. The front of the first platform base 721 extends past the front support columns 711a, 711b. In alternative embodiments, the first platform base 721 can connect to fewer than all of the support columns 711, such as only the back support columns 711c, 711d. The first platform base 721 includes a first platform surface 723 optionally partially covered in an anti-slip material. Similarly, the second platform base 722 has a rectangular shape that is connected to all four support columns 711, extending in a generally horizontal direction. The front of the second platform base does not extend as far horizontally as the first platform base 721. The second platform base 722 includes a second platform surface 724 also partially covered in an anti-slip material. The second platform surface 724 is configured in a stepped relationship with the first platform surface 723.

The frame assembly 710 also includes an upper support bar 716 that extends from the upper ends of the rear support columns 711c, 711d. The upper support bar 716 is of a generally curved shape and extends towards the front of the shoe tie-assisting device 700. The middle portion of the upper support bar 716 is covered with a gripping material, e.g. a rubber or foam, to create handle section 733. The gripping material allows a user to grip the handles without the risk that their hands will slip off of the handle section 733. The handle section 733 constitutes a handle assembly 730.

At the base of the bottom ends of the support columns 711 are base portions 115. These base portions 715 are preferably made of a material, e.g. a rubber, which can engage several floor surface types with a high degree of friction such that the shoe tie-assisting device 700 does not slide along the floor during use. As depicted, the base portions 715 are end-caps covering the bottom ends of the support columns 711.

Similar to the shoe tie-assisting devices discussed above, the shoe tie-assisting device 700 can be designed to be collapsible to reduce the space it occupies. Additionally, the components of the platform assembly 720 and the handle assembly 730 can be made to be adjustable so that persons of different heights can be comfortably accommodated.

### Eighth Embodiment

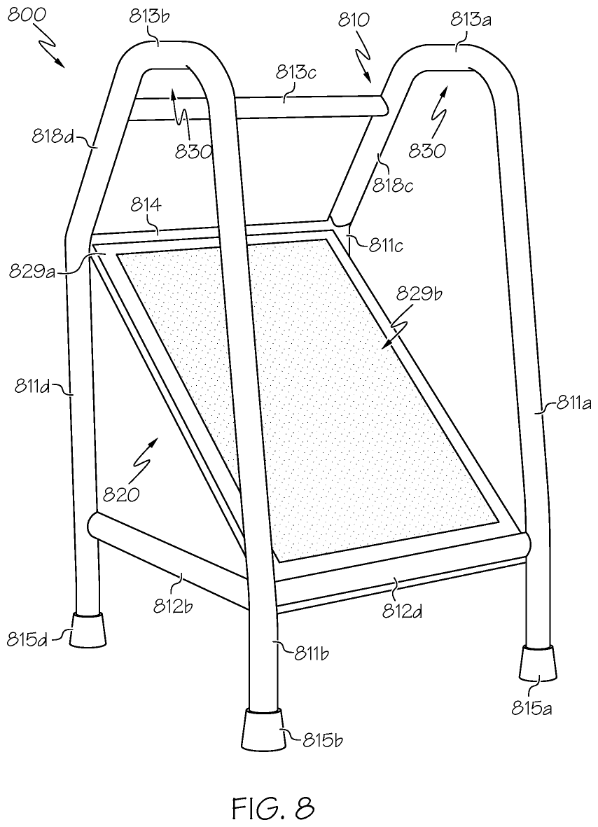

Referring to FIG. 8, a shoe tie-assisting device 800 according to an eighth embodiment has a frame assembly that includes four vertically-extending support columns 811 to create a quadrilateral-shaped space therebetween.

The frame assembly 810 also includes horizontally-extending upper support bars 813, which serve to connect the upper ends of the support columns 811. Specifically, the front right support column 811a is connected to the upper section 818c of the back right support column 811c with right upper support bar 813a and the front left support column 811b is connected to the upper section 818d of the back left support column 811d with left upper support bar 813b. Additionally, while not disposed at the same height as the right and left upper support bars 813a, 813b, a rear upper support bar 813c connects the upper section 818c of the back right support column 811c with connects the upper section 818d of the back left support column 811d. The right and left upper support bars 813a, 813b together constitute a handle assembly 830 and can each be optionally covered in gripping material (not shown), e.g. a rubber or foam which allows a user to grip the upper support bars 813a, 813b without the risk that their hands will slip off.

The frame assembly 810 further includes horizontally-extending lower support bars 812, which serve to connect lower ends of the support columns 811. Specifically, the front left support column 811b is connected with the rear left support column 811d with a left lower support bar 812b and the front right support columns 811a is connected with the front left support column 811b with a front lower support bar 812d. Additionally, while hidden from view, the front right support column 811a is connected with the rear right support column 811c with a right lower support bar (not shown).

The frame assembly 810 additionally includes an intermediate support bar 814 which connects the rear right support column 811c with the rear left support column 811d.

Extending between the front lower support bar 812d and the intermediate support bar 814 is a platform assembly 820 that includes an angled platform surface 829a partially covered in an anti-slip material 829b.

Similar to the shoe tie-assisting devices discussed above, the shoe tie-assisting device 800 can be designed to be collapsible to reduce the space it occupies. Additionally, the components of the platform assembly 820 and the handle assembly 830 can be made to be adjustable so that persons of different heights can be comfortably accommodated.

### Ninth Embodiment

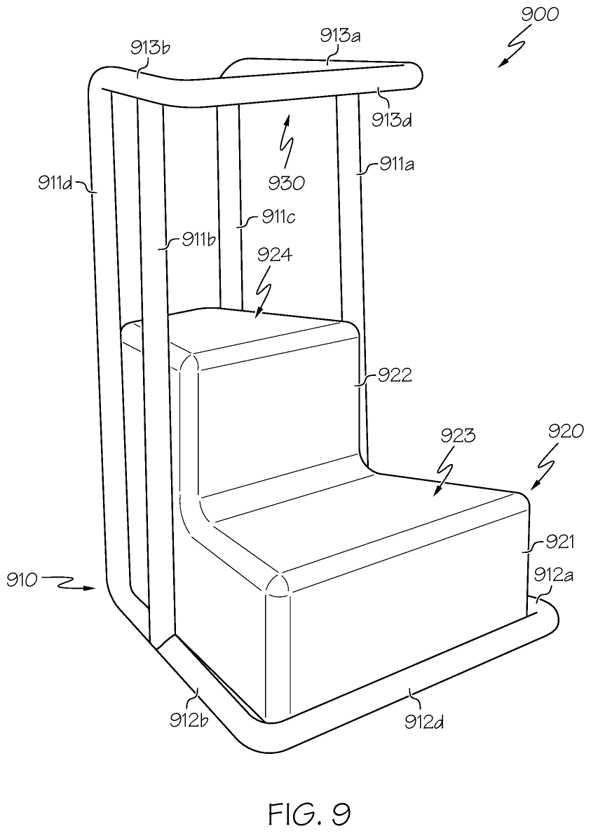

Referring to FIG. 9, a shoe tie-assisting device 900 according to an ninth embodiment has a frame assembly that includes four vertically-extending support columns 911 to create a quadrilateral-shaped space therebetween.

The frame assembly 910 also includes horizontally-extending lower support bars 912, some of which serve to connect lower ends of the support columns 911. Specifically, the front left support column 911b is connected with the rear left support column 911d with a left lower support bar 912b and the front right support column 911a is connected with the rear right support column 911c with a right lower support bar 912a. In addition to connecting adjacent supports columns 911, the lower support bars 912a, 912b extend past the front support columns 911a, 911b and are connected with a front lower support bar 912d.

Positioned between the lower support bars 912 is a foot-resting platform assembly 920. The platform assembly 920 in the form of a platform base that includes a first, lower base section 921 and a second, upper base section 922. The platform base 921, 922 can be made of a plastic material and resembles a set of stairs and the first base section 921 includes a first platform surface 923. The second base section 922 is disposed above the rear portion of the first base section 921 behind the first platform surface 924, and includes a second platform surface 924. The platform surface 923, 924 can optionally be partially covered in an anti-slip material.

The frame assembly 910 further includes horizontally-extending upper support bars 913, some of which serve to connect upper ends of the support columns 911. Specifically, the front left support column 911b is connected with the rear left support column 911d with a left upper support bar 913b and the front right support column 911a is connected with the rear right support column 911c with a right upper support bar 913a. In addition to connecting adjacent supports columns 911, the upper support bars 913a, 913b extend past the front support columns 911a, 911b and are connected with a front upper support bar 913d.

Similar to the shoe tie-assisting devices discussed above, the shoe tie-assisting device 900 can be designed to be collapsible to reduce the space it occupies. Additionally, the components of the platform assembly 920 and the handle assembly 930 can be made to be adjustable so that persons of different heights can be comfortably accommodated.

As discussed above, various alternative embodiments to the depicted shoe tie-assisting device embodiments are envisioned. Additionally, it is envisioned that any of the features in any of the above embodiments can be combined with features of any other of the above embodiments and/or any other features disclosed separately.

1. A shoe tie-assisting device comprising:
a frame assembly comprising at least three support columns defining a geometric space therebetween and support bars extending between the support columns such that the support columns are connected;
a platform assembly at least partially disposed within or below the geometric space defined by the support columns, comprising a first platform surface; and
a handle assembly comprising a first handle or pair of handles connected to the frame assembly and disposed at a height above the platform assembly, wherein the first handle or first pair of handles can be gripped by the hands of a person of typical height while the person is in an upright position.

2. The shoe tie-assisting device of claim 1, wherein the first handle or pair of handles is at least 30 inches from a bottom of the shoe tie-assisting device.

3. The shoe tie-assisting device of claim 1, the platform assembly comprising a second platform surface in a stepped relationship with first platform surface.

4. The shoe tie-assisting device of claim 2, wherein the second platform surface is disposed above the first platform surface, wherein the first platform surface extends further in a horizontal direction than the second platform surface.

5. The shoe tie-assisting device of claim 1, the handle assembly further comprising a second pair of handles disposed below the first handle or pair of handles extending from the frame assembly outside of the geometric space defined by the support columns.

6. The shoe tie-assisting device of claim 5, wherein the second pair of handles extends further in a horizontal direction than the platform assembly.

7. The shoe tie-assisting device of claim 5, wherein the first handle or pair of handles extends from the frame assembly outside of the geometric space defined by the support columns.

8. The shoe tie-assisting device of claim 7, wherein the first pair of handles extends further in a horizontal direction than the platform assembly.

9. The shoe tie-assisting device of claim 5, the handle assembly further comprising a third handle or pair of handles disposed below the second handle or pair of handles extending from the frame assembly outside of the geometric space defined by the support columns.

10. The shoe tie-assisting device of claim 9, wherein the third pair of handles extends further in a horizontal direction than the platform assembly.

11. The shoe tie-assisting device of claim 9, wherein the first handle or pair of handles is disposed above the geometric space defined by the support columns.

12. The shoe tie-assisting device of claim 11, wherein the first handle or pair of handles is a first handle connected to a support bar that extends upwards from and between two of the support columns.

13. A method for tying or untying shoes using the device of claim 1, comprising the steps of:
(i) a user gripping the first handle or one of the first pair of handles with one of their hands,
(ii) the user thereafter lifting a foot to the first platform surface,
(iii) the user thereafter lowering their upper body towards the first platform surface,
(iv) the user thereafter moving one of their hands toward their foot and tying or untying a shoe on the foot.

14. The method of claim 13, step (iii) further comprising the user moving one of their hands to one of a second pair of handles, thereby causing their upper body to lower towards the first platform surface.

15. The method of claim 14, further comprising a step of the user moving the other hand to the other of a second pair of handles.

16. The method of claim 13, further comprising a step of the user raising the foot to a second platform surface from the first platform surface prior to step (iv).

17. The method of claim 13, further comprising a step (v) after step (iv) a step of the user removing the foot from the shoe-tie assisting device.

18. The method of claim 17, further comprising a step (vi) after step (v) of the user placing their other foot on the first platform assembly and tying or untying a shoe.
